(19) United States
(12) Patent Application Publication
(10) Pub. No.: US 2014/0166121 A1
(43) Pub. Date: Jun. 19, 2014

(54) HYDROGEN SUPPLY APPARATUS OF FUEL CELL SYSTEM

(71) Applicant: Hyundai Motor Company, Seoul (KR)

(72) Inventors: Sekwon JUNG, Seongnam-si (KR); Hyeonseok BAN, Yongin-si (KR); Hyun Joon LEE, Yongin-si (KR); Bu Kil KWON, Suwon-si (KR); Yong Gyu NOH, Suwon-si (KR)

(73) Assignee: Hyundai Motor Company, Seoul (KR)

(21) Appl. No.: 14/098,391

(22) Filed: Dec. 5, 2013

(30) Foreign Application Priority Data
Dec. 13, 2012 (KR) 10-2012-0145741

(51) Int. Cl. F17C 13/00

(52) U.S. Cl. CPC F17C 13/002
USPC 137/154; 206/6

(57) ABSTRACT

A hydrogen supply apparatus of the fuel cell system includes a hydrogen tank and a pressure discharge line. The hydrogen tank is configured to store high-pressure hydrogen. A hydrogen supply line connected with a stack is disposed in the hydrogen tank. A pressure control valve configured to control hydrogen pressure of an anode of the stack is disposed in the hydrogen supply line. The pressure discharge line has a pressure relief valve and is disposed at the anode of the stack and a path connected thereto. The pressure discharge line is connected to an air supply line of the stack.

### CROSS-REFERENCE TO RELATED APPLICATION

This application claims benefit of priority to Korean Patent Application No. 10-2012-0145741 filed in the Korean Intellectual Property Office on Dec. 13, 2012, the entire contents of which are incorporated herein by reference.

### TECHNICAL FIELD

The present inventive concept relates to a hydrogen supply apparatus of a fuel cell system, and more particularly, to a hydrogen supply apparatus of a fuel cell system in which a hydrogen outlet of a pressure relief valve is connected to an air supply line or an air exhaust line.

### BACKGROUND

In general, a fuel cell system includes a fuel cell stack for generating electrical energy, a hydrogen supply apparatus for supplying hydrogen, which is fuel, to the fuel cell stack, and an air supply apparatus for supplying air necessary for electrochemical reaction to the fuel cell stack. The fuel cell system also includes a heat-water management system for removing reacted heat of the fuel cell stack to the outside of the system, controlling an operation temperature of the fuel cell stack, and performing a water management function, and a controller for controlling a general operation of the fuel cell system.

Here, the hydrogen supply apparatus includes a hydrogen tank, a high pressure/low pressure regulator, a hydrogen recirculating apparatus, and the like.

High pressure hydrogen is stored in the hydrogen tank, and the hydrogen tank is connected with the fuel cell stack by a hydrogen supply line.

Further, a pressure control valve for decompressing high pressure hydrogen to have pressure required in the fuel cell system and supplying the decompressed hydrogen is installed in the hydrogen supply line.

Here, the pressure control valve may be formed as a pressure regulator or a flow control valve.

In the meantime, the hydrogen stored in the hydrogen tank with high pressure is decompressed to appropriate pressure while passing through the pressure control valve to be supplied to the fuel cell stack. In this case, when failure occurs or an internal leakage is generated in the pressure control valve, the hydrogen is supplied to the fuel cell stack in a state where the hydrogen is not sufficiently decompressed, so that the fuel cell stack may be disrupted.

Accordingly, when predetermined pressure or higher is applied to the fuel cell stack by further mounting the pressure relief valve at a side of an anode of the fuel cell stack (e.g., between the pressure control valve and the fuel cell stack), surplus hydrogen is discharged to an engine compartment or to the atmosphere.

In this case, cracking pressure of the pressure relief valve is determined by a pressure difference between the pressure inside the fuel cell stack and the pressure of a place to which the hydrogen is discharged, and may be generally designed to be higher than the operation pressure of the fuel cell stack.

However, when the hydrogen is discharged to the engine compartment, the aforementioned technology may fail to meet the relevant regulation regarding a fuel cell system for a vehicle, and when the hydrogen is discharged to the atmosphere, a duct and a flow path for discharging the hydrogen gas to the atmosphere are additionally required, thereby incurring problems of cost increase and package deterioration.

Further, as the operation pressure of the fuel cell stack increases, the cracking pressure of the pressure relief valve increases. Thus, there are increased concerns regarding problems of an increasing limit by which over pressure is applied to the fuel cell stack without discharge of hydrogen by the pressure relief valve, and damage of the fuel cell stack.

The above information disclosed in this Background section is only for enhancement of understanding of the background of the inventive concept and therefore it may contain information that does not form the prior art that is already known.

### SUMMARY

The present inventive concept has been made in an effort to provide a hydrogen supply apparatus of a fuel cell system having advantages of protecting the fuel cell stack from over-pressure hydrogen by reducing cracking pressure of a pressure relief valve, securing safety, and meeting the relevant regulation regarding hydrogen gas discharge.

An aspect of the present inventive concept relates to a hydrogen supply apparatus of a fuel cell system including a hydrogen tank and a pressure discharge line. The hydrogen tank is configured to store high-pressure hydrogen. A hydrogen supply line connected with a stack is disposed in the hydrogen tank. A pressure control valve configured to control hydrogen pressure of an anode of the stack is disposed in the hydrogen supply line. The pressure discharge line has a pressure relief valve and is installed at the anode of the stack and a path connected thereto. The pressure discharge line is connected to an air supply line of the stack.

An air blower and a humidifier may be disposed in the air supply line, and the pressure discharge line may be connected to the air supply line between the air blower and the humidifier.

The pressure discharge line may be connected to the air supply line between the humidifier and the stack.

Another aspect of the present inventive concept encompasses a hydrogen supply apparatus of a fuel cell system, including a hydrogen tank and a pressure discharge line. The hydrogen tank is configured to store high-pressure hydrogen. A hydrogen supply line connected with a stack is disposed in the hydrogen tank. A pressure control valve configured to control hydrogen pressure of an anode of the stack is disposed in the hydrogen supply line. The pressure discharge line has a pressure relief valve and is disposed at the anode of the stack and a path connected thereto, and the pressure discharge line is connected to an exhaust line at an outlet side of the stack.

The exhaust line may be configured to perform exhaust via a humidifier.

The pressure discharge line may be connected to the exhaust line between the stack and the humidifier such that hydrogen is discharged to the exhaust line between the stack and the humidifier.

The pressure discharge line may be connected to the exhaust line at a rear end of a humidifier such that hydrogen is discharged to the exhaust line at the rear end of a humidifier.

The pressure control valve may include at least one selected among a pressure regulator, a flow control valve and an injector.

According to the present inventive concept, it is possible to reduce over-pressure applied to the fuel cell stack before the pressure relief valve is opened by reducing the cracking pressure of the pressure relief valve, and prevent the fuel cell stack from being damaged due to the over-pressure.

Further, the over-pressure hydrogen discharged through the pressure relief valve is discharged to the rear of the vehicle through the air supply line and the exhaust line, so that it is possible to improve safety compared to the discharge of the hydrogen to the engine compartment or the side of the vehicle.

Further, the present inventive concept has an advantage in an aspect of a package, and it is possible to reduce costs and meet the relevant regulation regarding hydrogen gas discharge.

### BRIEF DESCRIPTION OF THE DRAWINGS

The foregoing and other features of the inventive concept will be apparent from a more particular description of embodiments of the inventive concept, as illustrated in the accompanying drawings in which like reference characters may refer to the same or similar parts throughout the different views. The drawings are not necessarily to scale, emphasis instead being placed upon illustrating the principles of the embodiments of the inventive concept.

FIG. 1 is a configuration diagram of a hydrogen supply apparatus of a fuel cell system according to an exemplary embodiment of the present inventive concept.

FIG. 2 is a configuration diagram of a hydrogen supply apparatus of a fuel cell system according to an exemplary embodiment of the present inventive concept.

FIG. 3 is a configuration diagram of a hydrogen supply apparatus of a fuel cell system according to another exemplary embodiment of the present inventive concept.

FIG. 4 is a configuration diagram of a hydrogen supply apparatus of a fuel cell system according to another exemplary embodiment of the present inventive concept.

FIG. 5 is a graph illustrating cracking pressure of a pressure relief valve according to exemplary embodiments of the present inventive concept.

### DETAILED DESCRIPTION

In the following detailed description, only certain exemplary embodiments of the present inventive concept have been shown and described, simply by way of illustration. As those skilled in the art would realize, the described embodiments may be modified in various different ways, all without departing from the spirit or scope of the present inventive concept. Accordingly, the drawings and description are to be regarded as illustrative in nature and not restrictive. Like reference numerals designate like elements throughout the specification. In the detailed description, ordinal numbers are used for distinguishing constituent elements having the same terms, and have no specific meanings.

Hereinafter, exemplary embodiments of the present inventive concept will be described in detail with reference to the accompanying drawings.

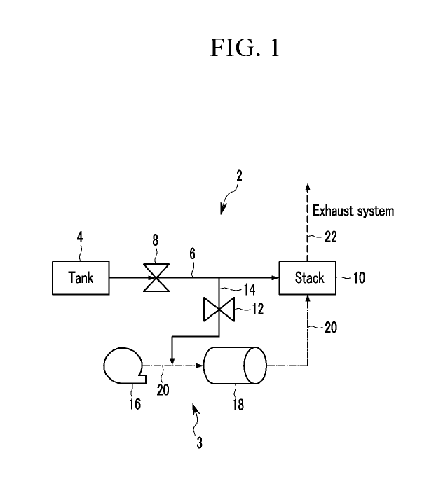

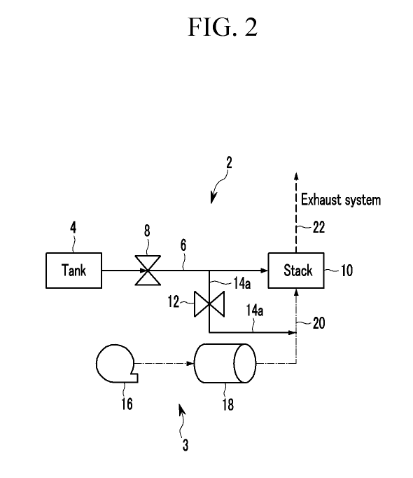

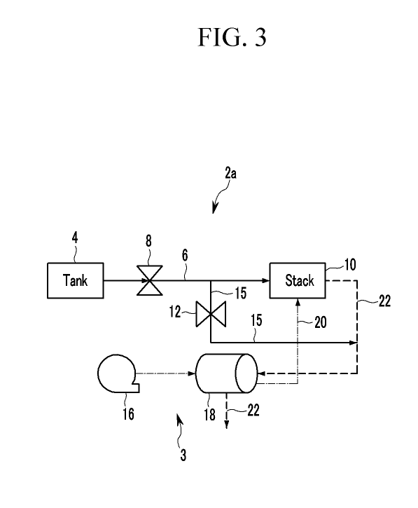

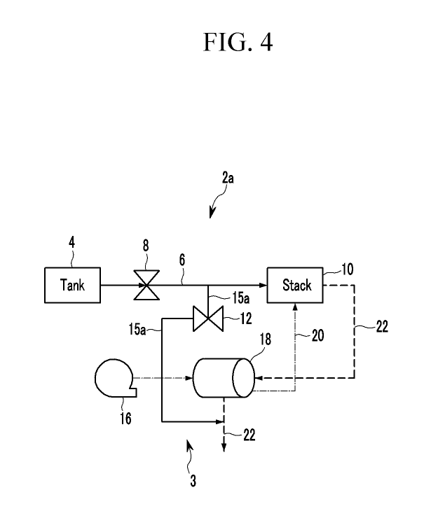

FIG. 1 is a configuration diagram of a hydrogen supply apparatus of a fuel cell system according to an exemplary embodiment of the present inventive concept, and FIG. 2 is a configuration diagram of a hydrogen supply apparatus of a fuel cell system according to an exemplary embodiment of the present inventive concept. FIG. 3 is a configuration diagram of a hydrogen supply apparatus of a fuel cell system according to another exemplary embodiment of the present inventive concept, and FIG. 4 is a configuration diagram of a hydrogen supply apparatus of a fuel cell system according to another exemplary embodiment of the present inventive concept.

The hydrogen supply apparatus 2 of the fuel cell system according to the exemplary embodiments of the present inventive concept illustrated in FIGS. 1 and 2 may be configured to discharge surplus hydrogen of a pressure relief valve 12 installed in a hydrogen supply line 6 between a hydrogen tank 4 and a stack 10 to an air supply line 20 of the stack 10.

The hydrogen supply apparatus 2 of the fuel cell system according to an exemplary embodiment of the present inventive concept may include the hydrogen tank 4, the hydrogen supply line 6, a pressure control valve 8, a pressure discharge line 14 or 14a (see FIG. 2), and the pressure relief valve 12.

The hydrogen supply apparatus may serve to supply hydrogen, which is fuel, to the fuel cell stack 10.

The fuel cell stack 10 may be formed as an electricity generation assembly in which a plurality of unit cells is continuously arranged, and each unit cell is included as a fuel cell which is a unit for generating electrical energy by electrochemical reaction between hydrogen and air.

The unit cell may include a membrane-electrode assembly and separators disposed in close contact with both sides of the membrane-electrode assembly, respectively.

In this case, the separator may be shaped like a plate having conductivity and channels. Through the channels, fuel flow and air flow to a close contact surface of the membrane-electrode assembly, respectively, are formed.

Further, the membrane-electrode assembly may be provided with an anode electrode (anode) in one surface, and an air electrode (cathode) in the other surface, and may have a structure in which an electrolyte membrane is formed between the anode and the cathode.

The anode may serve to make hydrogen supplied through the channel of the separator be oxidization-reacted to separate the hydrogen into electrons and hydrogen ions, and the electrolyte membrane may function to move the hydrogen ions to the cathode.

Further, the cathode serves to make the electrons and hydrogen ions received from the anode, and make the oxygen contained in the air received through the channel of the separator reduction-reacted to generate water and heat.

The hydrogen supply apparatus 2 may be connected to the anode of the fuel cell stack 10 through the hydrogen supply line 6, and the air supply device 3 may be connected to the cathode of the fuel cell stack 10 through the air supply line 20.

The air supply device 3 may include an air blower 16, a humidifier 18, and the air supply line 20.

The air introduced through the air blower 16 may be supplied to the cathode of the fuel cell stack 10 through the humidifier 18.

Further, the hydrogen that is not reacted in the fuel cell stack 10 may be discharged through an exhaust line 22.

The hydrogen tank 4 of the hydrogen supply apparatus 2 according to an exemplary embodiment of the present inventive concept may store high pressure hydrogen.

The hydrogen supply line 6 may be connected between the hydrogen tank 4 and the fuel cell stack 10.

Further, the pressure control valve 8 for decompressing the high pressure hydrogen supplied from the hydrogen tank 4 may be installed in the hydrogen supply line 6.

The pressure control valve 8 may include a pressure regulator, a flow control valve, and a valve for controlling pressure of a fluid, such as an injector.

The pressure regulator may decompress the high-pressure hydrogen to an appropriate pressure, and the flow control valve may permit only the predetermined amount of hydrogen to be supplied to the fuel cell stack 10 by controlling the amount of supply of the hydrogen.

Further, the pressure discharge line 14 or 14a (see FIG. 1) in which the pressure relief valve 12 is installed may be connected to the hydrogen supply line 6 between the pressure control valve 8 and the fuel cell stack 10.

The pressure relief valve 14 may be installed in order to prevent the fuel cell stack 10 from being disrupted when failure occurs in the pressure control valve 8, or a leakage and the like is generated in the hydrogen supply line 6, so that the hydrogen is supplied to the fuel cell stack 10 in a state where the hydrogen is not sufficiently decompressed.

The pressure relief valve 14 may be configured to be opened when the hydrogen has a predetermined pressure or higher.

The cracking pressure of the pressure relief valve 12 may be determined by a pressure difference between the pressure inside the fuel cell stack 10 and the pressure of the place to which the surplus hydrogen is discharged by the pressure relief valve 12.

Accordingly, in an exemplary embodiment of the present inventive concept, the surplus hydrogen is discharged to the air supply line 20, so that the cracking pressure of the pressure relief valve 12 may be determined by a difference between the operation pressure of the anode and the operation pressure of the cathode of the fuel cell stack 10.

When the pressure relief valve 14 is opened, over-pressure hydrogen may be discharged through the pressure discharge line 14 or 14a, and the pressure discharge line 14 or 14a according to the exemplary embodiment of the present inventive concept illustrated in FIGS. 1 and 2 may be connected to the air supply line 20 so that the over-pressure hydrogen is discharged through the air supply line 20.

As illustrated in FIG. 1, the pressure discharge line 14 may also be connected to the air supply line 20 between the air blower 16 and the humidifier 18.

The pressure discharge line 14 illustrated in FIG. 1 may be connected to a rear end of the air blower 16 and a front end of the humidifier 18, so that when the over-pressure is applied inside the fuel cell stack 10, the hydrogen is discharged to the rear end of the air blower 16 through the pressure relief valve 12.

Further, as illustrated in FIG. 2, the pressure discharge line 14a may also be connected to the air supply line 20 between the humidifier 18 and the fuel cell stack 10.

The pressure discharge line 14a illustrated in FIG. 2 may be disposed in an air flow path at the rear end of the humidifier 18 and inside the fuel cell stack 10, so that the length of the connection flow path is short, thereby achieving excellence in an aspect of the package and cost reduction.

Now, referring to FIGS. 3 and 4, a hydrogen supply apparatus 2a of a fuel cell system according to another exemplary embodiment of the present inventive concept will be described. Hereinafter, a detailed description of the same constituent elements as those of the hydrogen supply apparatus 2 of the fuel cell system according to the exemplary embodiment of the present inventive concept, as illustrated in FIGS. 1 and 2, will be omitted, and the same reference numerals designate the same constituent elements.

The hydrogen supply apparatus 2a of the fuel cell system according to another exemplary embodiment of the present inventive concept illustrated in FIGS. 3 and 4 may be configured such that the pressure relief valve 12 installed in the hydrogen supply line 6 between the hydrogen tank 4 and the fuel cell stack 10 discharges surplus hydrogen to the exhaust line 22.

The hydrogen supply apparatus 2a of the fuel cell system according to another exemplary embodiment of the present inventive concept may include the hydrogen tank 4, the hydrogen supply line 6, a pressure control valve 8, a pressure discharge line 15 (see FIG. 3) or 15a (see FIG. 4), and the pressure relief valve 12.

The exhaust line 22 of the hydrogen supply apparatus 2a of the fuel cell system according to another exemplary embodiment of the present inventive concept may be configured to perform exhausting through the humidifier 18.

The pressure discharge line 15 or 15a may be configured such that the hydrogen is discharged to the exhaust line 22 between the fuel cell stack 10 and the humidifier 18 as illustrated in FIG. 3, and may also be configured such that the hydrogen is discharged to the exhaust line 22 between the fuel cell stack 10 and the humidifier 18 as illustrated in FIG. 4.

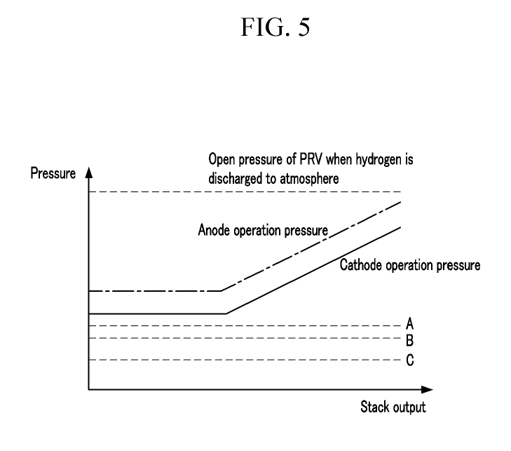

FIG. 5 is a graph illustrating the cracking pressure of the pressure relief valve according to exemplary embodiments of the present inventive concept.

Now, with reference to FIG. 5, comparison between the cracking pressure of the pressure relief valves 12 of the hydrogen supply apparatuses 2 and 2a of the fuel cell systems according to the exemplary embodiments of the present inventive concept and the cracking pressure when the hydrogen is discharged to the atmosphere will be described.

Referring to FIG. 5, it can be seen that a difference between the operation pressure of the anode and the operation pressure of the cathode of the fuel cell stack 10 is almost constant, and the cracking pressure of the pressure relief valve (PRV) 12 when the hydrogen is discharged to the atmosphere is set to be higher than the operation pressures of the anode and the cathode.

Line “A” in FIG. 5 represents the cracking pressure of the pressure relief valve 12 of the hydrogen supply apparatus 2 illustrated in FIG. 1, Line “B” in FIG. 5 represents the cracking pressure of the pressure relief valve 12 of the hydrogen supply apparatus 2 illustrated in FIG. 2, and Line “C” in FIG. 5 represents the cracking pressure of the pressure relief valve 12 of the hydrogen supply apparatus 2 illustrated in FIGS. 3 and 4.

As illustrated in FIG. 5, it can be seen that the hydrogen supply apparatuses 2 and 2a according to exemplary embodiments may considerably reduce the cracking pressure of the pressure relief valve 12 compared to the cracking pressure of the pressure relief valve 12 when discharging the hydrogen to the atmosphere.

Accordingly, a limit in which over-pressure is applied to the fuel cell stack 10 without hydrogen discharge by the pressure relief valve 12 goes down, thus reducing damage of the fuel cell stack 10.

Further, the over-pressure hydrogen discharged through the pressure discharge line 14, 14a, 15, or 15a may be discharged to the rear of a vehicle through the air supply line 20 and the exhaust line 22, thereby achieving an advantage of improved safety compared to the discharge of the hydrogen to the engine compartment or to the side of the vehicle.

While this inventive concept has been described in connection with what is presently considered to be practical exemplary embodiments, it is to be understood that the inventive concept is not limited to the disclosed embodiments, but is intended to cover various modifications and equivalent arrangements included within the spirit and scope of the appended claims.

### DESCRIPTION OF SYMBOLS

| | |
|---|---|
| 2, 2a: Hydrogen supply apparatus | 4: Hydrogen tank |
| 6: Hydrogen supply line | 8: Pressure control valve |
| 10: Fuel cell stack | 12: Pressure relief valve |

| | |
|---|---|
| 14, 14a, 15, 15a: Pressure discharge line | 16: Air blower |

| | |
|---|---|
| 18: Humidifier | 20: Air supply line |
| 22: Exhaust line | |

What is claimed is:

1. A hydrogen supply apparatus of a fuel cell system, comprising:
a hydrogen tank configured to store high-pressure hydrogen, wherein a hydrogen supply line connected with a stack is disposed in the hydrogen tank, and a pressure control valve configured to control hydrogen pressure of an anode of the stack is disposed in the hydrogen supply line; and
a pressure discharge line having a pressure relief valve disposed at the anode of the stack and a path connected thereto, the pressure discharge line being connected to an air supply line of the stack.

2. The hydrogen supply apparatus of claim 1, wherein:
an air blower and a humidifier are disposed in the air supply line, and the pressure discharge line is connected to the air supply line between the air blower and the humidifier.

3. The hydrogen supply apparatus of claim 1, wherein:
an air blower and a humidifier are disposed in the air supply line, and the pressure discharge line is connected to the air supply line between the humidifier and the stack.

4. A hydrogen supply apparatus of a fuel cell system, comprising:
a hydrogen tank configured to store high-pressure hydrogen, wherein a hydrogen supply line connected with a stack is disposed in the hydrogen tank, and a pressure control valve configured to control hydrogen pressure of an anode of the stack is disposed in the hydrogen supply line; and
a pressure discharge line having a pressure relief valve and disposed at the anode of the stack and a path connected thereto, the pressure discharge line being connected to an exhaust line at an outlet side of the stack.

5. The hydrogen supply apparatus of claim 4, wherein the exhaust line is configured to perform exhaust via a humidifier.

6. The hydrogen supply apparatus of claim 5, wherein the pressure discharge line is connected to the exhaust line between the stack and the humidifier such that hydrogen is discharged to the exhaust line between the stack and the humidifier.

7. The hydrogen supply apparatus of claim 5, wherein the pressure discharge line is connected to the exhaust line at a rear end of the humidifier such that hydrogen is discharged to the exhaust line at the rear end of the humidifier.

8. The hydrogen supply apparatus of claim 1, wherein the pressure control valve includes at least one selected from the group consisting of a pressure regulator, a flow control valve, and an injector.

9. The hydrogen supply apparatus of claim 4, wherein the pressure control valve includes at least one selected from the group consisting of a pressure regulator, a flow control valve, and an injector.
